(19) United States
(12) Patent Application Publication
(10) Pub. No.: US 2026/0063828 A1
(43) Pub. Date: Mar. 5, 2026

(54) POLYMER FILM WITH NARROW BAND DYE

(71) Applicant: RO Technologies, LLC, Las Vegas, NV (US)

(72) Inventors: Stephen S. Wilson, Las Vegas, NV (US); Bart E. Wilson, Las Vegas, NV (US); Roger Cone, Las Vegas, NV (US)

(21) Appl. No.: 18/823,572

(22) Filed: Sep. 3, 2024

(51) Int. Cl. G02B 1/115; G02B 1/04; G02B 1/14; G02B 3/00

(52) U.S. Cl. CPC G02B 1/115; G02B 1/041; G02B 1/14; G02B 3/0068

(57) ABSTRACT

A lens stack may include a polymer film, a coating containing one or more dyes, and a protective layer covering or encapsulating the coating. Each of the one or more dyes may be a narrow band dye and may have a full width at half maximum (FWHM) absorption bandwidth of 40 nm or less, for example. The coating may be an adhesive, and the protective layer may be an additional polymer film adhered to the first polymer film by the adhesive. Alternatively, the protective layer may be a scratch resistant topcoat or other layer that covers or encapsulates the coating. The lens stack may be the base layer of a removable lens stack including one or more removable lens layers.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

In recent years, makers of sunglasses have begun offering a range of so-called “color enhancing” lenses, which aim to filter out specific portions of the visible light spectrum in order to improve contrast between colors and make the wearer's view sharper and more vivid. In addition to their aesthetic appeal, color enhancing lenses are believed to improve reaction time and other aspects of performance in outdoor sports and activities as the wearer is able to take in a visual scene more clearly and quickly. The technology behind these color enhancing lenses typically makes use of color absorbing dyes that are designed to filter light in specific wavelength ranges with a relatively narrow bandwidth (e.g., 30 nm). For polycarbonate lenses, the dyes may be mixed into a batch of the polycarbonate resin, which may then be formed into a lens by extrusion followed by a casting or molding process. Examples of this type of process, as well as a discussion of underlying optical principles of using color absorbing dyes, can be found in Oakley's U.S. Pat. No. 10,871,661, entitled “Eyewear and Lenses with Multiple Molded Lens Components,” the entire contents of which is incorporated by reference herein.

Because of its lower cost and its superior resistance to deterioration by scratching or exposure to chemicals, clear polyethylene terephthalate (PET) may be preferable to polycarbonate in environments where durability is a concern or for certain optical applications such as face shields or windows. However, owing to the amorphous structure of PET film, mixing dyes into the solution prior to extruding results in uneven application of the dyes. Therefore, PET film is typically dyed by a process of immersing the already-formed film in a bath of solvents, followed by washing and heating to remove the dye carrier. Examples of this are described in U.S. Pat. No. 5,162,046, entitled “Method for Dyeing PET Films with Solvent Dye and Glycerol Triacetate, (Triacetin).” Unfortunately, this approach is unsuitable for mass production due to its multiple time-intensive subprocesses.

### BRIEF SUMMARY

The present disclosure contemplates various systems and methods for overcoming the above drawbacks accompanying the related art. One aspect of the embodiments of the present disclosure is a removable lens stack. The removable lens stack may comprise a base layer including a first polymer film such as a polyethylene terephthalate (PET) film, a first adhesive containing one or more dyes, and a second polymer film adhered to the first polymer film by the first adhesive. Each of the one or more dyes may be a narrow band dye and may have a full width at half maximum (FWHM) absorption bandwidth of 40 nm or less, for example. The removable lens stack may further comprise one or more removable lens layers. Each of the one or more removable lens layers may include a polymer film and a second adhesive whose peel strength is less than that of the first adhesive. The one or more removable lens layers may be stacked on top of the base layer such that the second adhesive of each of the one or more removable lens layers adheres the polymer film of the removable lens layer to the polymer film of an immediately preceding removable lens layer (in the case of a second or subsequent removable lens layer) or to the second polymer film of the base layer (in the case of the first removable lens layer).

The one or more removable lens layers may comprise any number of removable lens layers, such as one, two, three, seven, or ten removable lens layers. The polymer film of each of the one or more removable lens layers may be treated to enhance adhesion of the second adhesive to the polymer film. In each of the one or more removable lens layers, the second adhesive may cover less than an entirety of the polymer film so as to define a dry lane.

Another aspect of the embodiments of the present disclosure is a lens stack. The lens stack may comprise a first polymer film such as a polyethylene terephthalate (PET) film, a coating on the first polymer film containing one or more dyes, and a protective layer encapsulating the coating. Each of the one or more dyes may be a narrow band dye and may have a full width at half maximum (FWHM) absorption bandwidth of 40 nm or less, for example.

The protective layer may comprise a second polymer film. The coating may comprise an adhesive, and the second polymer film may be adhered to the first polymer film by the adhesive. The lens stack may comprise a scratch resistant topcoat provided on a side of the second polymer film opposite the adhesive. The lens stack may comprise a pressure sensitive adhesive (PSA) provided on a side of the first polymer film opposite the coating. A peel strength of the PSA may be less than that of the adhesive containing the one or more dyes. The PSA may include a UV protective additive. The lens stack may comprise a release liner on a side of the PSA opposite the first polymer film. The protective layer may comprise a scratch resistant topcoat instead of (or in addition to) the second polymer film.

Another aspect of the embodiments of the present disclosure is a method of manufacturing a lens stack. The method may comprise providing a first polymer film such as a polyethylene terephthalate (PET) film, coating the first polymer film with a coating containing one or more dyes, and encapsulating the coating with a protective layer. Each of the one or more dyes may be a narrow band dye and may have a full width at half maximum (FWHM) absorption bandwidth of 40 nm or less, for example.

The protective layer may comprise a second polymer film, and the encapsulating may include stacking the second polymer film on the first polymer film with the coating therebetween. The protective layer may comprise a scratch resistant topcoat, and the encapsulating may include applying the scratch resistant topcoat to the coating. The coating may include slot-die coating, gravure coating, or reverse gravure coating, for example. The method may comprise stacking one or more removable lens layers on the protective layer. Each of the one or more removable lens layers may include a polymer film and an adhesive. The one or more removable lens layers may be stacked on top of the protective layer such that the adhesive of each of the one or more removable lens layers adheres the polymer film of the removable lens layer to the polymer film of an immediately preceding removable lens layer (in the case of a second or subsequent removable lens layer) or to the protective layer (in the case of the first removable lens layer). The method may comprise applying a pressure sensitive adhesive (PSA) on a side of the first polymer film opposite the coating. The method may comprise applying a release liner on a side of the PSA opposite the first polymer film.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a cross-sectional view of a removable lens stack;

FIG. 2 is a cross-sectional view of another lens stack; and

FIG. 3 is a cross-sectional view of another lens stack.

### DETAILED DESCRIPTION

The present disclosure encompasses various embodiments of a polymer lens stack that incorporates color enhancing narrow band dyes and may be used for face shields, windows, and other optically clear applications, along with methods of manufacture and use thereof. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that relational terms such as first and second and the like are used solely to distinguish one from another entity without necessarily requiring or implying any actual such relationship in order between such entities.

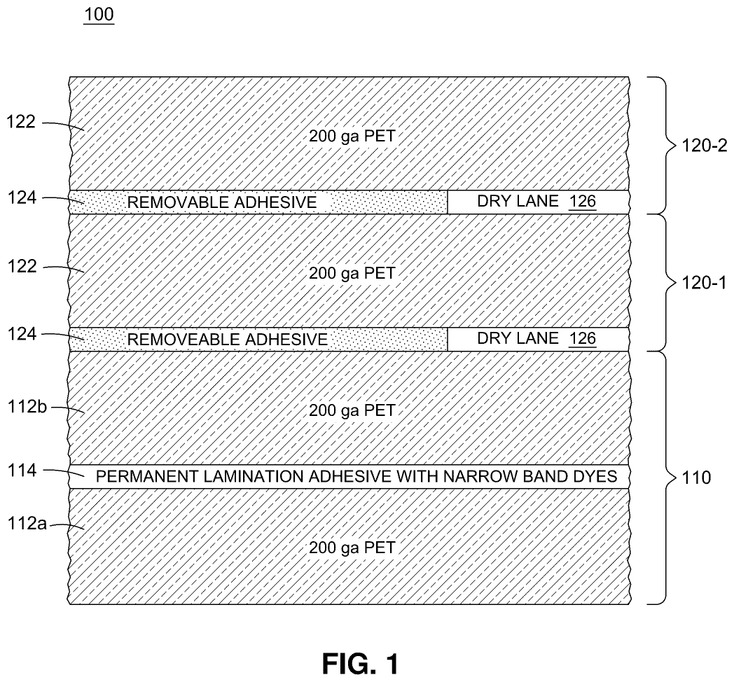

FIG. 1 is a cross-sectional view of a removable lens stack 100 in accordance with one or more embodiments of the present disclosure. The removable lens stack 100 may include a base layer 110 that may be affixed (e.g., mechanically or with adhesive) to a face shield or other surface such as a goggle lens or visor or a transparent window of a helmet, hood, or gown, for example, or to a vehicular or architectural window. Alternatively, the base layer 110 of the removable lens stack 100 may itself serve as the lens, visor, face shield, window, or other surface, e.g., by being attached at a perimeter thereof to a frame of the helmet, hood, gown, goggle, vehicle, building, or other article. Stacked on top of the base layer 110 (e.g., by a roll-to-roll lamination process), the removable lens stack 100 may further include one or more removable lens layers 120-1, 120-2, etc. (collectively 120), each comprising a polymer film 122 and an adhesive 124 for adhering the removable lens layer 120 to the previous adhesive lens layer 120 (or, in the case of the innermost removable lens layer 120, to the base layer 110). As debris accumulates on the outermost removable lens layer 120 during surgical procedures, offroad racing, or other activities, or as the layer 120 becomes pitted or otherwise damaged, the wearer may simply tear it off to reveal the next pristine lens layer 120 (or base layer 110) underneath. Depending on the number of removable lens layers 120 in the stack 100, the process may be repeated several times before replacing (or replenishing) the stack 100.

In order to provide the stack 100 with enhanced visual acuity in different environments, one or more narrow band dyes may be incorporated into the base layer 110. A narrow band dye may have a full width at half maximum (FWHM) absorption bandwidth of 40 nm or less (e.g., 40-15 nm), for example, and may be selected for absorption in a specific frequency band of visual light, as may be optimized for the particular application, the intended environment, or the individual wearer (e.g., a person with red-green color blindness) based on computer simulation output. Advantageously, the narrow band dye(s) may be incorporated into the base layer 110 of the stack 100 despite the fact that the base layer 110 may comprise one or more polymer films such as polyethylene terephthalate (PET) films and may thus be difficult to dye evenly and efficiently by known methods. In particular, in contrast to conventional methods used for polycarbonate lenses such as mixing the dyes into the polycarbonate resin, the one or more dyes may instead be combined with a binder to produce an adhesive or other coating 114 containing the dye(s), such as the permanent lamination adhesive shown in FIG. 1. The coating 114 may be a wet mount adhesive, for example, as disclosed in U.S. Pat. No. 9,128,545, entitled “Touch Screen Shield,” the entire contents of which is incorporated by reference herein. The coating 114 may then be applied to a polymer film 112a by slot-die coating, gravure coating, or reverse gravure coating, for example, while the polymer film 112a is on roll-to-roll processing equipment, allowing for a uniform coating of the polymer film 112a that is not affected by any uneven amorphous structure of the polymer. Moreover, time-intensive processes such as immersing the polymer film 112a in a solvent bath and heating in an oven may be completely avoided.

As shown in the example construction of FIG. 1, the base layer 110 may include a second polymer film 112b that is permanently adhered to the first polymer film 112a (e.g., by a roll-to-roll lamination process) and may act as a protective layer encapsulating the coating 114. Thereafter, any number of removable lens layers 120 may be applied, all of which may benefit from the narrow band dyes contained in the coating 114 of the base layer 110. Each of the removable lens layer(s) 120 may include a polymer film 122 and an adhesive 124 whose peel strength is low enough for a person to easily tear off the layer 120 from the remainder of the stack 100. In particular, the peel strength of each adhesive 124 should be less than that of the adhesive or other coating 114 that is present in the base layer 110 (and intended to be permanent). In this way, the removable lens layer(s) 120 may be peeled off without risking accidental removal of the second polymer film 112b or other protective layer of the base layer 110 (and unwanted exposure of the narrow band dyes). The removable lens layer(s) 120 may be stacked on top of the base layer 110 such that the adhesive 124 of each of the one or more removable lens layers 120 adheres the polymer film 122 of the removable lens layer 120 to the polymer film 122 of an immediately preceding removable lens layer 120 or, in the case of the innermost removable lens layer 120-1, to the second polymer film 112b of the base layer 110. In some cases, the adhesive 124 of each removable lens layer 120 may cover less than an entirety of the polymer film 122 on which it is provided, so as to define a dry lane 126 which may provide a place to grip the removable lens layer 120, making it easier for a person to separate a removable lens layer 120 from the stack. Example stacking and adhesive curing processes that may be used in connection with producing the removable lens stack 100 are described in U.S. Pat. No. 11,933,943, entitled “Stack of Sterile Peelable Lenses with Low Creep,”the entire contents of which is incorporated by reference herein.

Various surface treatments may be applied to the removable lens layers 120 (as well as to the base layer 110), typically in the form of very thin coatings that help promote an outcome on a surface of the polymer film 112a, 112b, 122. Of particular use in the context of the disclosed removable lens stack 100, each removable lens layer 120 may be treated to enhance adhesion of the adhesive 124 to the polymer film 122 of the same layer 120. The adhesive promoting treatment may be a very thin (e.g., 5-10 nm) rough coat of acrylic or polyurethane, for example. Alternatively, the polymer film 122 may undergo a corona treatment to promote adhesion. By promoting the adhesion of the polymer film 122 (also referred to as “priming” the surface), it can be ensured that the adhesive 124 stays with the polymer film 122 as a given removable lens layer (e.g., layer 120-2) is removed from the layer underneath (e.g., layer 120-1). Advantageously, this may prevent unwanted residue from transferring to the next layer 120 (or to the base layer 110), which could impair the view through the lens stack 100. In order to keep optical distortion as low as possible, the refractive indices of the polymer films 112a, 112b, 122 and any adhesives or other coatings 114, 124 that are used, as well as any additional layers and additives contemplated herein, may be matched (e.g., to within 0.2) as described in U.S. Pat. No. 9,295,297, entitled “Adhesive Mountable Stack of Removable Layers” (“'297 patent”), the entire contents of which is incorporated by reference herein.

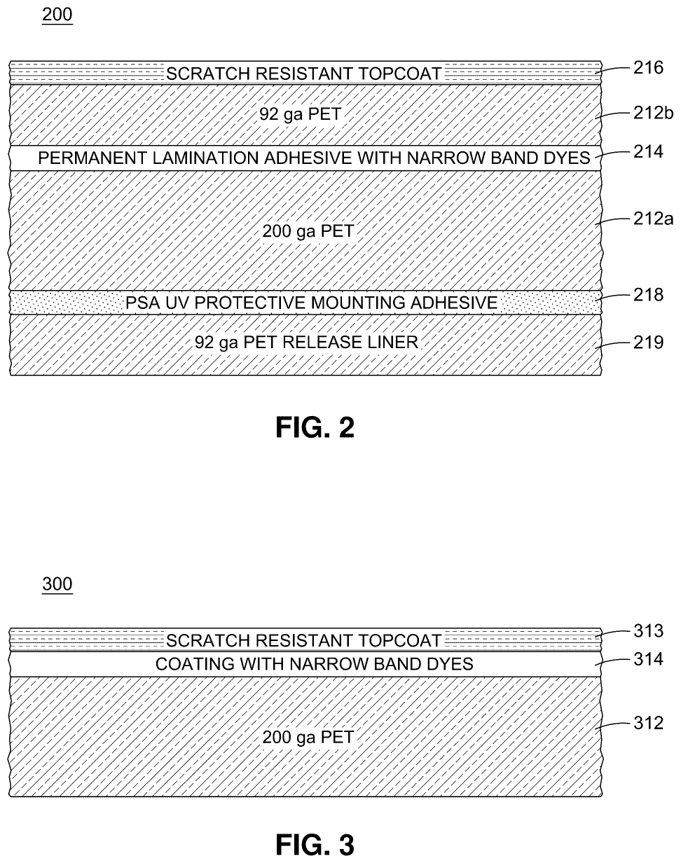

FIG. 2 is a cross-sectional view of another lens stack 200, this one illustrating a case where there are no removable lens layers 120 (though it is contemplated that removable lens layers 120 may be added to the construction of FIG. 2). The lens stack 200 exemplified by FIG. 2 may include first and second polymer films 212a, 212b that may be the same as the first and second polymer films 112a, 112b of the removable lens stack 100, though FIG. 2 illustrates that these polymer films 212a, 212b need not have the same thickness. (The exemplary thicknesses in the illustrated embodiments are measured in gauge where a gauge value of 1 ga is equal to 0.01 mil.) The lens stack 200 shown in FIG. 2 may have a coating 214 between the first and second polymer films 212a, 212b that may be the same as the coating 114 of FIG. 1 and may, in particular, contain the narrow band dye(s) contemplated herein. The example lens stack 200 may differ from the removable lens stack 100 in the inclusion of a scratch resistant topcoat 216 such as a hard coat, which may be particularly suitable in a more permanent application (e.g., one that omits removable lens layers 120 that are periodically torn off). The lens stack 200 may additionally differ from the removable lens stack 100 in the inclusion of a pressure sensitive adhesive (PSA) 218 for mounting the lens stack 200 to a surface. An example use case for such a mountable lens stack 200 may be an architectural window such as a window in a house or other building. The lens stack 200 may be applied to the interior of such a window to enhance the view through the window, with the specific colors that are enhanced in some cases being selected in consideration of the environment that is visible through the window (e.g., enhanced greens for a garden view, enhanced blues for an ocean view, etc.).

The PSA 218 may be a dry mount adhesive as disclosed, for example, in the above-mentioned '297 patent. The PSA 218 may be an acrylic or silicon adhesive and may, in particular, be an optically clear adhesive (OCA). As illustrated in FIG. 2, the PSA 218 may be covered with a release liner 219 (e.g., a thin polymer film as shown) that may protect the PSA 218 prior to application of the lens stack 200 on a window, face shield, or other article. The release liner 219 may be applied to the stack 200 by a lamination process, for example. In order to protect the stack 200 from damage caused by ultraviolet (UV) light, as well as to protect users of the stack 200 (e.g., inhabitants of a building featuring color enhanced windows), the PSA 218 may include a UV protective additive. Suitable UV protective additives are described in U.S. Pat. No. 11,490,667, entitled “Low Haze UV Blocking Removable Lens Stack,” the entire contents of which is incorporated by reference herein.

FIG. 3 is a cross-sectional view of another lens stack 300, this one illustrating that the narrow band dye(s) need not necessarily be mixed into a laminating adhesive and provided between two polymer films as in the examples of the coatings 114, 214 of FIGS. 1 and 2. As such, the lens stack 300 may more generally include a coating 314, which may be any type of coating (e.g., a topcoat, a clearcoat, an adhesive, etc.) and may, in particular, contain the narrow band dye(s) blended with a binder to produce a suitable consistency for coating the polymer film 312. The protective layer 313 likewise need not be limited to a lamination such as a second polymer film 112b, 212b and may more generally be any kind of layer that covers or encapsulates the coating 314 to prevent it from being damaged or removed. In the illustrated example, the protective layer 313 comprises a scratch resistant topcoat such as a hard coat, which may be the same as the scratch resistant topcoat 216 described in relation to FIG. 2 except that in this case it is used to protect the coating 314 containing the narrow band dyes (without there necessarily being any intervening polymer film 212b). A scratch resistant topcoat may be an acrylic or fluoropolymer hard coat containing silica beads, for example, and may be applied to the lens stack 200, 300 by various processes such as spin coating, dip coating, or vacuum deposition.

It should be appreciated that the disclosed subject matter also contemplates any combinations of the features described in relation to the illustrated lens stacks 100, 200, 300. For example, the lens stack 300 including only a single polymer film 312, a coating 314 containing narrow band dyes, and a protective layer 313 may be provided with a PSA 218 (and release liner 219) as described in relation to FIG. 2. Likewise, either of the constructions illustrated in FIGS. 2 and 3 may serve as a base layer of a removable lens stack 100 (e.g., in place of the base layer 110) and may be provided with one or more removable lens layers 120. By the same token, the removable lens stack 100 having the removable lens layer(s) 120 may include the PSA 218 (and release liner 219) so that the base layer 110 may be adhered to a pre-existing face shield, window, or other surface. Any and all such combinations may be constructed and implemented in a variety of applications and use cases including but not limited to those described herein, including smaller format applications (e.g., using 15-inch polymer film) to be worn in front of a wearer's face or eyes such as in a medical face shield or a racing visor, as well as larger format applications (e.g., using 60-inch polymer film) to be used as a window or a window covering in vehicles or buildings.

In the above examples, it is described that the coating 114, 214, 314 may include one or more narrow band dyes. However, it is recognized that incorporating two or more dyes into the same coating 114, 214, 314 may in some cases affect the narrow band absorption of the individual dyes. It is also contemplated, therefore, that multiple dye-containing coatings 114, 214, 314 may be included in the same lens stack 100, 200, 300, with each coating 114, 214, 314 containing a different dye (e.g., a dye that is selected for absorption in a different frequency band) or a different combination of one or more dyes. In such a lens stack 100, 200, 300 containing two or more coatings 114, 214, 314, the coatings may be applied one after the other onto the same polymer film. For example, in the case of the lens stack 300, a first coating 314 with one or more narrow band dyes may be applied to the polymer film 312, and then a second coating 314 with a different set of one or more narrow band dyes may be applied on top of the first coating 314. The protective layer 313 may then encapsulate both coatings 314. As another possibility, the two or more coatings may be applied to different layers of the stack 100, 200, 300. For example, in the case of the lens stack 200, a first coating 214 with one or more narrow band dyes may be applied to the polymer film 212a, and a second coating 214 with a different set of one or more narrow band dyes may be applied to the polymer film 212b (e.g., with a scratch resistant topcoat 216 or other protective layer protecting the second coating 214). The disclosed subject matter contemplates any and all such combinations of dye-containing coatings, which may be applied one on top of the other, on different polymer films in the same stack, or on opposite sides of the same polymer film (e.g., one on the outward facing side and one on the inward facing side), for example. It should also be noted that one or more narrow band dyes may be provided in a lens stack 100, 200, 300 that also includes one or more broadband dyes (e.g., having a FWHM absorption bandwidth of greater than 40 nm), either in a separate coating or in the same coating(s) as the narrow band dye(s). For example, a broadband neutral gray absorbing coating may be applied to one or more of the polymer lenses in order to modify the attenuation and/or the net reflected color of a lens stack 100, 200, 300.

Any of the removable lens stacks 100, 200, 300 or combinations and variants thereof may include additional layers and additives, such as anti-reflective coating(s) as described in U.S. Pat. No. 11,585,962, entitled “Transparent Covering Having Anti-Reflective Coatings,” a thermochromic film as described in U.S. Patent Application Pub. No. 2021/0070017, entitled “Nano Particle Solar Control Film,” a UV blocking layer or additive as described in U.S. Pat. No. 11,490,667, entitled “Low Haze UV Blocking Removable Lens Stack,” moth eye and/or other antireflective coating(s) as described in U.S. Pat. No. 11,307,329, U.S. Pat. No. 11,709,296, and U.S. Patent Application Pub. No. 2024/0151881, all entitled “Low Reflectance Removable Lens Stack,” coatings of differing refractive index as described in U.S. Pat. No. 10,427,385, entitled “Low Reflectance Optical Web,” and/or antistatic coating(s) as described in U.S. Pat. No. 11,808,952, entitled “Low Static Optical Removable Lens Stack,” the entire contents of each of which is incorporated by reference herein.

Any of the polymer films described herein may be polyester films made of polyethylene terephthalate (PET), such as biaxially-oriented PET or BoPET. However, the contemplated polymer films are not limited in this respect and may, for example, be acrylic such as polymethyl methacrylate (PMMA), amorphous polyethylene terephthalate (APET), polyethylene terephthalate glycol (PETG), thermoplastic polyurethane (TPU), or polycarbonate. The polymer films may be selected for particular modulation transfer function (MTF) data or may be fabricated while actively monitoring the MTF data in a continuous or batch-to-batch process as described in U.S. Pat. Nos. 11,648,723 or 11,912,001, both entitled “Method and Apparatus for Reducing Non-Normal Incidence Distortion in Glazing Films,” or as described in U.S. Pat. No. 11,548,356, entitled “Protective Barrier for Safety Glazing,” the entire contents of each of which is incorporated by reference herein. In this regard, providing a polymer film may include, for example, melting a resin, extruding the melted resin through a die to produce a film, and cooling the film. Examples of TPU films may be found in U.S. Patent Application Pub. No. 2023/0249524, entitled “Multi-layer Windshield Film having Progressive Thickness Layers,” the entire contents of which is incorporated by reference herein.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A removable lens stack comprising:
a base layer including a first polymer film, a first adhesive containing one or more dyes, and a second polymer film adhered to the first polymer film by the first adhesive, each of the one or more dyes having a full width at half maximum (FWHM) absorption bandwidth of 40 nm or less; and
one or more removable lens layers, each of the one or more removable lens layers including a polymer film and a second adhesive whose peel strength is less than that of the first adhesive, the one or more removable lens layers being stacked on top of the base layer such that the second adhesive of each of the one or more removable lens layers adheres the polymer film of the removable lens layer to the polymer film of an immediately preceding removable lens layer or to the second polymer film of the base layer.

2. The removable lens stack of claim 1, wherein the one or more removable lens layers comprises at least two removable lens layers.

3. The removable lens stack of claim 1, wherein the polymer film of each of the one or more removable lens layers is treated to enhance adhesion of the second adhesive to the polymer film.

4. The removable lens stack of claim 1, wherein, in each of the one or more removable lens layers, the second adhesive covers less than an entirety of the polymer film so as to define a dry lane.

5. A lens stack comprising:
a first polymer film;
a coating on the first polymer film, the coating containing one or more dyes each having a full width at half maximum (FWHM) absorption bandwidth of 40 nm or less; and
a protective layer encapsulating the coating.

6. The lens stack of claim 5, wherein the protective layer comprises a second polymer film.

7. The lens stack of claim 6, wherein the coating comprises an adhesive, and the second polymer film is adhered to the first polymer film by the adhesive.

8. The lens stack of claim 7, further comprising a scratch resistant topcoat provided on a side of the second polymer film opposite the adhesive.

9. The lens stack of claim 7, further comprising a pressure sensitive adhesive (PSA) provided on a side of the first polymer film opposite the coating.

10. The lens stack of claim 9, wherein a peel strength of the PSA is less than that of the adhesive containing the one or more dyes.

11. The lens stack of claim 9, wherein the PSA includes a UV protective additive.

12. The lens stack of claim 9, further comprising a release liner on a side of the PSA opposite the first polymer film.

13. The lens stack of claim 5, wherein the protective layer comprises a scratch resistant topcoat.

14. A method of manufacturing a lens stack, the method comprising:
providing a first polymer film;
coating the first polymer film with a coating containing one or more dyes each having a full width at half maximum (FWHM) absorption bandwidth of 40 nm or less; and
encapsulating the coating with a protective layer.

15. The method of claim 14, wherein the protective layer comprises a second polymer film, said encapsulating including stacking the second polymer film on the first polymer film with the coating therebetween.

16. The method of claim 14, wherein the protective layer comprises a scratch resistant topcoat, said encapsulating including applying the scratch resistant topcoat to the coating.

17. The method of claim 14, wherein said coating includes slot-die coating.

18. The method of claim 14, further comprising stacking one or more removable lens layers on the protective layer, each of the one or more removable lens layers including a polymer film and an adhesive, the one or more removable lens layers being stacked on top of the protective layer such that the adhesive of each of the one or more removable lens layers adheres the polymer film of the removable lens layer to the polymer film of an immediately preceding removable lens layer or to the protective layer.

19. The method of claim 14, further comprising applying a pressure sensitive adhesive (PSA) on a side of the first polymer film opposite the coating.

20. The method of claim 19, further comprising applying a release liner on a side of the PSA opposite the first polymer film.
